(19) United States
(12) Patent Application Publication
(10) Pub. No.: US 2025/0053679 A1
(43) Pub. Date: Feb. 13, 2025

(54) DATABASE PROCESSING METHOD, DEVICE, EQUIPMENT AND MEDIUM

(71) Applicant: Beijing Volcano Engine Technology Co., Ltd., Beijing (CN)

(72) Inventor: Xinying YANG, Los Angeles, CA (US)

(21) Appl. No.: 18/779,981

(22) Filed: Jul. 22, 2024

(30) Foreign Application Priority Data
Aug. 7, 2023 (CN) 202310988636.0

(51) Int. Cl. G06F 21/62; G06F 21/60

(52) U.S. Cl. CPC G06F 21/6227; G06F 21/604; G06F 2221/2141

(57) ABSTRACT

Embodiments of the present disclosure provide a database processing method and apparatus, a device and a medium. The method includes: receiving an access request for a database, wherein the access request carries a user identifier of an access party and a data processing instruction, the data processing instruction is used for instructing to process specified data in the database to obtain target data; in response to determining that the specified data is encrypted data, querying an authorization information table in the database based on the user identifier of the access party, and detecting whether the access party is an authorized user of the specified data; and in response to determining that the access party is the authorized user of the specified data, executing the data processing instruction to process the specified data to obtain the target data, and returning the target data in response to the access request.

### CROSS-REFERENCE TO RELATED APPLICATION(S)

This application claims priority to Chinese Application No. 202310988636.0 filed Aug. 7, 2023, the disclosure of which is incorporated herein by reference in its entity.

### FIELD

The present disclosure relates to the technical field of data processing, and in particular to a database processing method and apparatus, a device and a medium.

### BACKGROUND

In the prior art, the credibility of a processing environment in which a database is located is very poor, so that a lawbreaker can easily perform a malicious attack on the database to crack and tamper important data. In order to ensure the security of data, an existing data processing process requires multiple times of communication between three parties, that is, the database, an another security platform and a client, to complete once data processing, for example, the client encrypts data A and then transmits the data A to the database, the database decrypts the data A and then re-encrypts and sends the data A to the other security platform, and the other security platform decrypts the data A according to a processing operator and then re-encrypts and returns the data A to the database. Therefore, once transmission of the data A is subjected to multiple times of communication and multiple encryption and decryption operations. This solution may only ensure the security, but cannot guarantee the processing efficiency of the database, especially when the quantity demanded of the database is particularly large, this solution easily causes a system crash, therefore it is difficult to satisfy actual service requirements.

### SUMMARY

In order to solve the above technical problems or at least partially solve the above technical problems, the present disclosure provides a database processing method and apparatus, a device and a medium, which improve the efficiency of data processing and ensure the security and reliability of data processing.

An embodiment of the present disclosure provides a database processing method, including:
receiving an access request for a database, wherein the access request carries a user identifier of an access party and a data processing instruction, the data processing instruction is used for instructing to process specified data in the database to obtain target data, and the database is deployed in a separate secure execution environment;
in response to determining that the specified data is encrypted data, querying an authorization information table in the database based on the user identifier of the access party, and detecting whether the access party is an authorized user of the specified data, wherein the encrypted data is data stored in the database in an encrypted form, and the authorization information table is used for recording authorized user information configured by a data party for the encrypted data; and
in response to determining that the access party is the authorized user of the specified data, executing the data processing instruction to process the specified data to obtain the target data, and returning the target data in response to the access request.

An embodiment of the present disclosure further provides a database processing apparatus, including:
a receiving module, configured to receive an access request for a database, wherein the access request carries a user identifier of an access party and a data processing instruction, the data processing instruction is used for instructing to process specified data in the database to obtain target data, and the database is deployed in a separate secure execution environment;
a detection module, configured to: in response to determining that the specified data is encrypted data, query an authorization information table in the database based on the user identifier of the access party, and detect whether the access party is an authorized user of the specified data, wherein the encrypted data is data stored in the database in an encrypted form, and the authorization information table is used for recording authorized user information configured by a data party for the encrypted data; and
a feedback module, configured to: in response to determining that the access party is the authorized user of the specified data, execute the data processing instruction to process the specified data to obtain the target data, and return the target data in response to the access request.

An embodiment of the present disclosure further provides an electronic device, including: a processor; and a memory, configured to store an executable instruction for the processor, wherein the processor is configured to read the executable instruction from the memory, and execute the executable instruction to implement the database processing method provided in the embodiments of the present disclosure.

An embodiment of the present disclosure further provides a computer-readable storage medium, storing a computer program, wherein the computer program is configured to execute the database processing method provided in the embodiments of the present disclosure.

Compared with the prior art, the technical solutions provided in the embodiments of the present disclosure have the following advantages:

The database processing solution provided in the embodiments of the present disclosure includes: receiving an access request for a database, wherein the access request carries a user identifier of an access party and a data processing instruction, the data processing instruction is used for instructing to process specified data in the database to obtain target data, and the database is deployed in an separate secure execution environment; in response to determining that the specified data is encrypted data, querying an authorization information table in the database based on the user identifier of the access party, and detecting whether the access party is an authorized user of the specified data, wherein the encrypted data is data stored in the database in an encrypted form, and the authorization information table is used for recording authorized user information configured by a data party for the encrypted data; and in response to determining that the access party is the authorized user of the specified data, executing the data processing instruction to process the specified data to obtain the target data, and returning the target data in response to the access request. In the embodiments of the present disclosure, the database is completely packaged in the separate secure execution environment, so that the database is integrated with the executable environment, and related data is isolated in the executable environment, thereby not only ensuring the security of data, but also improving efficiency of data processing. In this way, the interaction between a client and the database is more convenient, there is no need to encrypt the data and then transmit the same on the client, and there is also no need for the database to perform frequent data interaction with another security platform. Moreover, in the present solution, encryption detection is performed on the specified data corresponding to the data processing instruction in the access request sent by the access party, in response to determining that the specified data is encrypted data, authorization detection is performed for the user identifier of the access party based on the authorization information table in the database, a corresponding processing operation is executed on the specified data according to an authorization detection result, and feedback is performed, thereby ensuring the security and reliability of data processing.

### BRIEF DESCRIPTION OF THE DRAWINGS

The above and other features, advantages and aspects of various embodiments of the present disclosure will become more apparent in combination with the drawings and with reference to specific embodiments below. Throughout the drawings, the same or similar reference signs indicate the same or similar elements. It should be understood that the drawings are schematic and that original members and elements are not necessarily drawn to scale.

FIG. 1 is a schematic flowchart of a database processing method provided in an embodiment of the present disclosure;

FIG. 2 is a schematic diagram of a scenario of database processing provided in an embodiment of the present disclosure;

FIG. 3 is a schematic diagram of another scenario of database processing provided in an embodiment of the present disclosure;

FIG. 4 is a schematic structural diagram of a database processing apparatus provided in an embodiment of the present disclosure; and

FIG. 5 is a schematic structural diagram of an electronic device provided in an embodiment of the present disclosure.

### DETAILED DESCRIPTION OF EMBODIMENTS

Hereinafter, embodiments of the present disclosure will be described in more detail with reference to the drawings. Although some embodiments of the present disclosure have been illustrated in the drawings, it should be understood that the present disclosure may be implemented in various forms and should not be construed as being limited to the embodiments set forth herein; and rather, these embodiments are provided to help understand the present disclosure more thoroughly and completely. It should be understood that the drawings and embodiments of the present disclosure are for exemplary purposes only and are not intended to limit the protection scope of the present disclosure.

It should be understood that various steps recorded in method embodiments of the present disclosure may be executed in different sequences and/or in parallel. In addition, the method embodiments may include additional steps and/or omit executing the steps shown. The scope of the present disclosure is not limited in this respect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that, concepts such as “first” and “second” mentioned in the present disclosure are only intended to distinguish different apparatuses, modules or units, and are not intended to limit the sequence or interdependence of functions executed by these apparatuses, modules or units.

It should be noted that, the modifiers such as “one” and “more” mentioned in the present disclosure are intended to be illustrative and not restrictive, and those skilled in the art should understand that the modifiers should be interpreted as “one or more” unless the context clearly indicates otherwise.

The names of messages or information interacted between a plurality of apparatuses in the embodiments of the present disclosure are for illustrative purposes only and are not intended to limit the scope of these messages or information.

In order to solve the above problems, an embodiment of the present disclosure provides a database processing method. In the method, a database is deployed in an separate secure execution environment, and further, the database is deployed in a trusted execution environment (TEE). The trusted execution environment is a secure area of device hardware or software, which is isolated from a master operating system and provides a trusted environment to execute sensitive or critical codes and data. The security in the TEE mainly comes from the isolation between the TEE and the master operating system and hardware protection measures, and the database is deployed in a trusted hardware based trusted execution environment. The TEE provides a secure execution environment, in which the stored and executed codes and data are protected. The TEE itself is composed of special hardware in a processor, and prevents, by means of some security protection mechanisms, the outside from tampering or stealing the codes and data in the TEE. In addition, the TEE does not allow an ordinary application program to access the codes and data therein, thereby improving the security of the system. In this way, the TEE becomes an ideal platform for application programs such as encryption, digital security and security authentication. In the embodiments of the present disclosure, the database is completely packaged in an executable environment, so that the database is integrated with the executable environment; and related data is isolated in the executable environment, so that the security of the data is ensured, the interaction between a client and the database is more convenient, there is no need to encrypt the data and then transmit the same on the client, and there is also no need for the database to perform frequent data interaction with another security platform, thereby improving the efficiency of data processing.

The database processing method is described below in combination with specific embodiments.

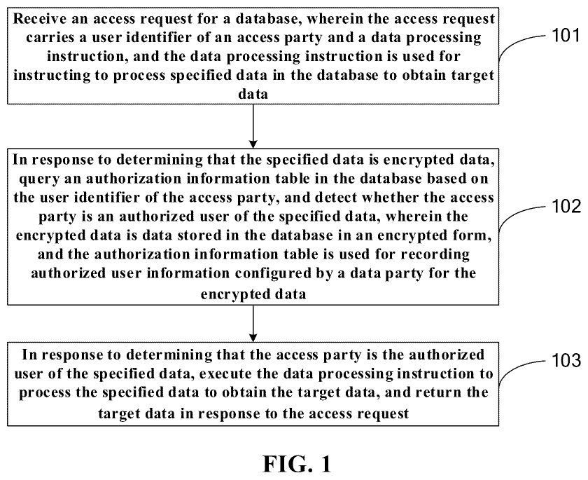

FIG. 1 is a schematic flowchart of a database processing method provided in an embodiment of the present disclosure, and the method may be executed by a database processing apparatus, wherein the apparatus may be implemented by using software and/or hardware, and may be generally integrated in an electronic device. As shown in FIG. 1, the method includes the following:

Step 101: an access request for a database is received, where the access request carries a user identifier of an access party and a data processing instruction, and the data processing instruction is used for instructing to process specified data in the database to obtain target data.

The access request may be a request sent by a user for accessing data in the database, the access request may carry parameters required for accessing the data, and in the embodiments of the present disclosure, the access request may include the user identifier of the access party and the data processing instruction. The user identifier of the access party may be a user identifier of an access user who currently sends the access request, and the identifier is used for uniquely representing the current access user. The data processing instruction may be used for instructing to process the specified data in the database to obtain the target data, and may be expressed as a structured query language (SQL). The specified data may include all data or data corresponding to a filtered data identifier of a data filtering condition involved in the data processing instruction.

Specifically, after receiving the access request for the database, the data processing apparatus may analyze the data processing instruction to obtain the filtered data identifier in the data filtering condition. Specifically, the data processing apparatus may perform SQL analysis processing on the data processing instruction, and determine, as the specified data, data corresponding to the filtered data identifier. The data filtering condition is used for screening the target data from the database.

The data filtering condition is used for screening out, from the database, target data satisfying an access party requirement, and the access party requirement is a condition corresponding to the data filtering condition. The filtered data identifier may be a data identifier included in the data filtering condition, the data identifier may uniquely represent one piece of data, the data herein may include, but is not limited to, at least one column of data, at least one row of data, or at least one data element or the like in at least one data table, the filtered data identifier may include a data table identifier and a data position, and the data position may include a column identifier of column data, a row identifier of row data, or a row identifier and a column identifier of a data element. The specified data is data corresponding to the filtered data identifier, for example, when the data table identifier in the filtered data identifier of one data filtering condition is A and the data position is a column identifier C1, then the specified data corresponding to the filtered data identifier may include all data included in a column C1 of a data table A.

When the data processing instruction is an SQL statement, a “where” condition statement in the SQL statement may be used as a screening statement of the data filtering condition. A “where” clause in the SQL statement is used for screening a keyword of a data record that satisfies a condition, is usually used in statements such as “select” and “delete”, and is used for specifying condition restrictions corresponding to some data filtering condition libraries, so as to retrieve, update or delete data from a specified database. Predicates in the “where” clause are specific expressions of these conditions and may contain a plurality of conditions, and these conditions are connected together by logical operators (e.g., AND, OR, NOT) to implement a complex screening operation of the data filtering condition.

For example, if the data processing instruction is expressed as “select t2.c1 from t1, t2 where t2.c1=t1.c1” by the SQL statement, the data filtering condition corresponding to the statement is that a column where data the same as that in a column c1 in a table t1 is located is determined in a table t2, and the specified data corresponding to the filtered data identifier includes data included in the column c1 in the table t2 and the column c1 in the table t2.

Step 102: in response to determining that the specified data is encrypted data, an authorization information table in the database is queried based on the user identifier of the access party, and whether the access party is an authorized user of the specified data is determined, where the encrypted data is data stored in the database in an encrypted form, and the authorization information table is used for recording authorized user information configured by a data party for the encrypted data.

It should be understood that, in the embodiments of the present disclosure, in order to implement the integration of the database and the TEE, all data related to the database is packaged in the TEE, and the encrypted data and the authorization information table are two kinds of data therein.

Specifically, the database processing apparatus may determine whether the specified data is encrypted data, and may specifically detect, based on the filtered data identifier, whether the corresponding specified data is encrypted data stored in the database.

The encrypted data is ciphertext data on which authorized access needs to be performed, which is generated by the TEE applies an encryption key corresponding to the data party to performing encryption processing on the specified encryption data in the database, that is, data stored in the encrypted form. In some embodiments, the database processing method may further include: receiving a creation instruction sent by the data party, where the creation instruction includes a user identifier of the data party, a data table identifier, and a specified encryption data identifier corresponding to the data table identifier; and for data corresponding to the data table identifier and the data identifier, performing encryption processing on the data by using an encryption key that is stored in the TEE and corresponds to the user identifier of the data party, so as to generate encrypted data, filling the specified encrypted data identifier in an encrypted data field of a relationship table, and writing, based on a mapping relationship between the encrypted data field and a creation user field in the relationship table, the user identifier of the data party into the creation user field in a manner of corresponding to the specified encryption data identifier.

The creation instruction may be an instruction used for creating the encrypted data and storing a relationship table of a mapping relationship between the encrypted data and a creation user, the creation instruction may include specific parameters required for creation, including the user identifier of the data party, the data table identifier, and the specified encryption data identifier corresponding to the data table identifier, wherein the user identifier of the data party is used for representing a current creation user, the data table identifier represents a data table that needs to be encrypted currently, and the specified encryption data identifier corresponding to the data table identifier represents specific data that needs to be encrypted in the data table that needs to be encrypted. The encryption key of the TEE may be set according to scenario requirements, and generally, a public key of the TEE may be broadcast and sent to the access party or the like, so that the access party can perform decryption processing on the encrypted data according to the public key.

After receiving the creation instruction sent by the data party, the database processing apparatus may acquire a corresponding data table from the database according to the data table identifier in the creation instruction, acquire specified encryption data from the data table according to the specified encryption data identifier corresponding to the data table identifier, and then perform encryption processing on the specified encryption data according to the encryption key corresponding to the user identifier of the data party in the TEE, so as to generate the encrypted data. That is, in the present embodiment, the encryption processing is only performed on the specified encryption data instead of on all data in the data table, thereby greatly improving the data encryption efficiency.

Then, the specified encryption data identifier is filled in the encrypted data field of the relationship table configured by the database, and the user identifier of the data party is filled, based on the mapping relationship between the encrypted data field and the creation user field in the relationship table, in the creation user field of the relationship table in a manner of corresponding to the specified encrypted data identifier.

In one embodiment of the present disclosure, after the relationship table is packaged in the TEE, it is detected whether filtered data corresponding to the filtered data identifier is encrypted data stored in the database, that is, whether the filtered data is encrypted data processed by the TEE. That is, data is directly queried in the TEE without directly performing data interaction with the database. In the present embodiment, the encrypted data field in the relationship table is queried according to the filtered data identifier. Obviously, if the filtered data identifier is queried in the encrypted data field, it is determined that the filtered data is encrypted data stored in the database, and if the filtered data identifier is not queried in the encrypted data field, it is determined that the filtered data is not encrypted data stored in the database.

The authorized user information includes at least one authorized user identifier, and represents that at least one user corresponding to the at least one authorized user identifier is allowed to access the encrypted data. In some embodiments, the database processing method may further include: receiving an authorization configuration instruction sent by the data party, wherein the authorization configuration instruction carries a user identifier of the data party, a data identifier of the specified data and a user identifier of the authorized user, and the authorization configuration instruction is used for instructing to configure that the authorized user is authorized and allowed to access to the specified data; and in response to the authorization configuration instruction, recording, in the authorization information table, a correspondence among the user identifier of the data party, the data identifier of the specified data and the user identifier of the authorized user.

The authorization information table and the above relationship table may be the same table and may also be different tables. The authorization configuration instruction may be a specific instruction used for configuring user information of authorized access for the encrypted data. The authorization configuration instruction may include an authorization data identifier for allowing authorized access, an authorized user identifier corresponding to the authorization data identifier, and the user identifier of the data party. The authorization data identifier may be a data identifier of the encrypted data on which authorized access needs to performed, the authorized user identifier may be an identifier of a user who is allowed to access the encrypted data, and the user identifier of the data party may be an identifier of a user who creates the encrypted data. In the embodiments of the present disclosure, it is taken as an example that an authorized user is configured for the specified data, the authorization configuration instruction includes the data identifier of the specified data, the user identifier of the corresponding authorized user, and the user identifier of the data party.

The database processing apparatus receives the authorization configuration instruction sent by the data party. The database processing apparatus writes, based on a mapping relationship between the encrypted data field and an authorized user field in the authorization information table, the authorized user identifier into the authorized user field in a manner of corresponding to the authorization data identifier, so as to indicate that the user corresponding to the authorized user identifier is allowed to access the encrypted data corresponding to the authorization data identifier. The database processing apparatus writes the user identifier of the data party into the creation user field in a manner of corresponding to the authorization data identifier. When the authorization configuration instruction carries the user identifier of the data party, the data identifier of the specified data and the user identifier of the authorized user, the user identifier of the authorized user is written into the authorized user field of the authorization information table in a manner of corresponding to the data identifier of the specified data, and the user identifier of the data party is written into the creation user field of the authorization information table in a manner of corresponding to the data identifier of the specified data, thereby recording the correspondence among the user identifier of the data party, the data identifier of the specified data and the user identifier of the authorized user.

User identifiers of a plurality of authorized users are configured for one piece of specified data of the data party in the authorization information table. The authorization information table is dynamically updated with the authorization configuration instruction sent by the data party. That is, for the specified data in the authorization information table, the user identifiers of one or more authorized users may be configured, so as to indicate that the one or more authorized users are allowed to access the specified data. Writing the authorized user identifier into the authorized user field in the manner of corresponding to the authorization data identifier may be that: one authorized user identifier may be written into the authorized user field in the manner of corresponding to the authorization data identifier for indicating that only one user corresponding to the one authorized user identifier is allowed to access the encrypted data corresponding to the authorization data identifier; or, a plurality of authorized user identifiers are written into the authorized user field in the manner of corresponding to the authorization data identifier for indicating that a plurality of users corresponding to the plurality of authorized user identifiers are allowed to access the encrypted data corresponding to the authorization data identifier. That is, one or more authorized user identifiers may be written into the authorized user field corresponding to the authorization data identifier for indicating that the one or more users corresponding to the one or more authorized user identifiers are allowed to access the encrypted data corresponding to the authorization data identifier.

In some embodiments, upon detecting that the specified data is encrypted data, the data processing apparatus may query the authorization information table, acquire the user identifier of the authorized user corresponding to the specified data based on the correspondence among the user identifier of the data party, the data identifier of the specified data and the user identifier of the authorized user, so as to obtain an authorized user identifier set, that is, acquire an authorized user identifier set in the authorized user field corresponding to the filtered data identifier. If the user identifier of the access party is queried in the authorized user identifier set, the data processing apparatus determines that the access party is an authorized user who is allowed to view the specified data; and if the user identifier of the access party is not queried in the authorized user identifier set, the data processing apparatus determines that the access party is not the authorized user who is allowed to view the specified data. Therefore, processing failure prompt information may be returned to the access party, and the failure prompt information may be set according to scenario requirements, which is not limited herein. In the present embodiment, when the access party is not the authorized user who is allowed to view the specified data, mask marking may be performed for the specified data, and the masked specified data is sent to the corresponding access party.

In some embodiments, the specified data is at least one column of encrypted data in at least one data table corresponding to a specified column identifier, or the specified data is at least one row of encrypted data in at least one data table corresponding to a specified row identifier, or the specified data is at least one encrypted data element in at least one data table corresponding to the specified column identifier and the specified row identifier. That is, the specified data may include, but is not limited to, at least one column of encrypted data, at least one row of encrypted data, or at least one encrypted data element in the at least one data table, which is specifically set according to actual scenario requirements.

Step 103: in response to determining that the access party is the authorized user of the specified data, the data processing instruction is executed to process the specified data to obtain the target data, and the target data is returned in response to the access request.

In one embodiment of the present disclosure, when it is detected that the access party is an authorized user of the specified data, the data processing instruction is executed to screen out the target data from the database according to the data filtering condition, that is, the specified data is processed to obtain the target data, and the target data is fed back to the access party. Therefore, for the specified data corresponding to the data processing instruction in the access request sent by the access party, in response to determining that the specified data is encrypted data processed by the TEE, permission authorization for indicating whether the user is authorized is performed based on the user identifier of the access party and the authorization information table, multiple encryption and decryption processes between the client and the database are avoided by the permission authorization, for example, there is no need to perform the following: the acquired target data is encrypted and then transmitted to the database, and the database encrypts the target data and then sends the same to the client where the access party is located, thereby improving the efficiency of data processing, and the encrypted data is only fed back to the authorized user, thereby ensuring the security and reliability of data processing.

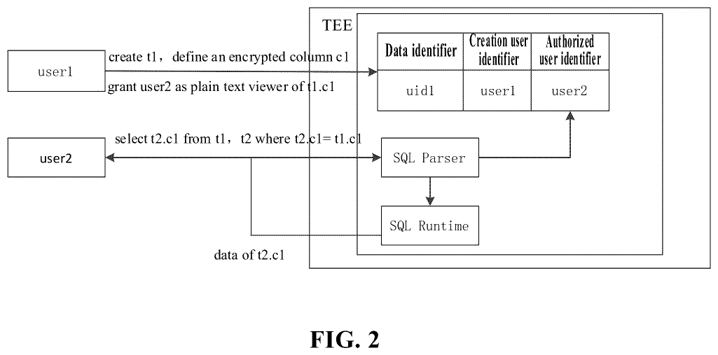

For example, as shown in FIG. 2, the creation instruction sent by the data party user 1 specifies that the data stored in the database in the encrypted form is a column c1 in a data table t1, the data party is a creation user, and the user identifier of the data party is user1 (corresponding to the create T1, define an encrypted column c1 in FIG. 2). A data identifier uid1 of the column c1 in the data table t1 is filled in the encrypted data field of the relationship table configured by the database, and the user identifier user1 of the data party is filled in the creation user field of the relationship table. The authorization configuration instruction (corresponding to “grant user2 as plain text viewer of t1.c1” in FIG. 2) sent by the data party is received, the data identifier of the specified data in the authorization configuration instruction is the data identifier uid1 included in the column c1 in the data table t1 and a user identifier of the authorized user corresponding to the data identifier uid1 is user2, and the correspondence among the user identifier of the data party, the data identifier uid1 of the specified data and the user identifier user2 of the authorized user is recorded in the authorization information table, that is, the user identifier user2 of the authorized user is filled in the authorized user field corresponding to the data identifier uid1 in the authorization information table.

In the present embodiment, with continued reference to FIG. 2, if the user identifier of the access party is user2, the data processing instruction is “select t2.c1 from t1, t2 where t2.c1=t1.c1” (i.e., values corresponding to a column t2.c1 are selected from a table t1 and a table t2, where the data filtering condition is that t2.c1 is equal to the data of t1.c1). In a specific execution process, the processing execution is converted into an SQL statement by an SQL Parser operation, and a corresponding syntax is executed by SQL Runtime so as to query the encrypted data field in the relationship table according to the filtered data identifier of the data filtering condition, and it is discovered that the specified data of the filtered data identifier uid1 corresponding to t1.c1 belongs to the encrypted data. Therefore, the authorization information table is queried, and the user identifier user2 of the authorized user corresponding to the specified data is acquired based on the correspondence among the user identifier of the data party, the data identifier of the specified data and the user identifier of the authorized user, so as to obtain an authorized user identifier set, that is, the authorization information table is queried to acquire a user identifier set user2 in the authorized user field corresponding to the filtered data identifier uid1. Therefore, the user2 is an authorized user, and thus related target data that is equal to t1.c1 in t2 (data of t2.c1 in the figure) is returned to the user2.

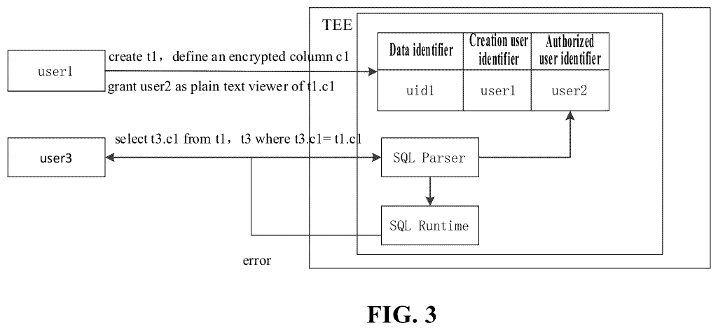

Similarly, referring to FIG. 3, if the user identifier of the access party is user3, the data processing instruction is “select t3.c1 from t1, t3 where t3.c1=t1.c1” (i.e., values corresponding to a column t3.c1 are selected from the table t1 and a table t3, where the data filtering condition is that t3.c1 is equal to the data of t1.c1), the encrypted data field in the relationship table is queried according to the filtered data identifier of the data filtering condition, and it is discovered that the specified data of the filtered data identifier corresponding to t1.c1 belongs to the encrypted data. Therefore, the authorization information table is queried, and the user identifier user2 of the authorized user corresponding to the specified data is acquired based on the correspondence among the user identifier of the data party, the data identifier of the specified data and the user identifier of the authorized user, so as to obtain an authorized user identifier set, that is, the authorization information table is queried to acquire a user identifier set user2 in the authorized user field corresponding to the filtered data identifier, therefore the user3 is not an authorized user, and thus processing failure prompt information (error in FIG. 3) is returned to the user3.

Therefore, in the embodiments of the present disclosure, a database management system (DBMS) is packaged in the TEE (referred to as a TEE-DBMS integrated technology), so that related data filtering conditions of the client and the database are read in the TEE. This technology is a secure data processing architecture that closely integrates the TEE with the DBMS, and may provide higher-level data security protection. In this architecture, the TEE may be used for executing all SQL operations, including creation, update, deletion, query, calculation and processing of data, so as to implement a complete database system function. The core idea of the TEE-DBMS integrated technology is to use the TEE to replace a traditional DBMS engine, and all data operations are completed in the TEE. The TEE-DBMS integrated technology has the following advantages: 1. data confidentiality: the TEE may protect the confidentiality of data by using security computing technologies such as encryption, hash and digital signature. These techniques may prevent leakage, tampering, forgery and the like of the data. 2. Data integrity: the TEE may provide a powerful data integrity protection mechanism according to a data structure, a service rule, and the like. These mechanisms may ensure that the data is not tampered, lost and damaged during transmission, thereby ensuring the data integrity. 3. Fine-granularity access control: the TEE may provide a flexible data access control policy, which only allows the authorized user to access the data, thereby preventing unauthorized access and utilization. 4. Higher security: the DBMS is packaged in the TEE, so that attack aspects are reduced, and security threats to a database system are reduced. The TEE further has autonomous security assessment and detection capabilities, which may further improve the security of the database system.

In addition, in the present embodiment, data processing may be implemented by direct interaction between the access party and the executable environment, thereby avoiding frequent encryption and decryption processes between the database and the related security platform, ensuring both security and database processing efficiency, especially when the quantity demanded of the database is particularly large, actual service requirements are better satisfied, and the encrypted-stat data is only to the authorized user, thereby greatly improving the security and reliability of data processing.

In summary, in the database processing solution provided in the embodiments of the present disclosure, an access request for a database is received, where the access request carries a user identifier of an access party and a data processing instruction, the data processing instruction is used for instructing to process specified data in the database to obtain target data, and the database is deployed in a separate secure execution environment. In response to determining that the specified data is encrypted data, an authorization information table in the database is queried based on the user identifier of the access party, and it is detecting whether the access party is an authorized user of the specified data, where the encrypted data is data stored in the database in an encrypted form, and the authorization information table is used for recording authorized user information configured by a data party for the encrypted data. In response to determining that the access party is the authorized user of the specified data, the data processing instruction is executed to process the specified data to obtain the target data, and the target data is returned in response to the access request. In the embodiments of the present disclosure, the database is completely packaged in the separate secure execution environment, so that the database is integrated with the executable environment, and related data is isolated in the executable environment, thereby not only ensuring the security of data, but also improving efficiency of data processing. In this way, the interaction between the client and the database is more convenient, there is no need to encrypt the data and then transmit the same on the client, and there is also no need for the database to perform frequent data interaction with another security platform. Moreover, in the present solution, encryption detection is performed on the specified data corresponding to the data processing instruction in the access request sent by the access party; in response to determining that the specified data is encrypted data, authorization detection is performed for the user identifier of the access party based on the authorization information table in the database; a corresponding processing operation is executed on the specified data according to an authorization detection result; and feedback is performed, thereby ensuring the security and reliability of data processing.

In some embodiments of the present disclosure, the authorization configuration instruction may further include an authorized access time limit. The authorization information table records a correspondence among the user identifier of the data party, the data identifier of the specified data, the user identifier of the authorized user and the authorized access time limit. The authorized access time limit is used for limiting an access time of the authorized user for the specified data.

The authorized access time limit may be that a time is set for the encrypted data, the access to the encrypted data is allowed within the time, and the access to the encrypted data is not allowed exceeding the time. The authorization configuration instruction in the above embodiments may further include the authorized access time limit, and the authorized access time limit corresponds to the specified data. The database processing apparatus may record, in the authorization information table, the correspondence among the user identifier of the data party, the data identifier of the specified data, the user identifier of the authorized user and the authorized access time limit. That is, on the basis that the user identifier of the authorized user is written into the authorized user field in the authorization information table in a manner of corresponding to the data identifier of the specified data, the authorized access time limit of the data identifier of the specified data is also written into the authorized user field corresponding to the data identifier of the specified data, which indicates that a user corresponding to the user identifier of the authorized user is only allowed to access the specified data within the authorized access time limit.

When the authorized access time limit corresponds to the authorized user identifier, the database processing apparatus may record, in the authorization information table, a correspondence among the user identifier of the data party, the authorization data identifier, the authorized user identifier and the authorized access time limit, that is, on the basis that the authorized user identifier is written into the authorized user field in the authorization information table in a manner of corresponding to the authorization data identifier, the authorized access time limit of the authorized user identifier is also written into the authorized user field corresponding to the authorization data identifier, which indicates that a user corresponding to the authorization data identifier is only allowed to access the encrypted data corresponding to the authorization data identifier within the authorized access time limit.

When it is detected that the access party is an authorized user, the authorization information table may be queried to acquire the authorized access time limit corresponding to the user identifier of the access party in the authorized user field, it is determined whether a current access time is within the authorized access time limit corresponding to the user identifier of the access party. If so, the data processing instruction is executed to process the specified data to obtain the target data, and the target data is returned in response to the access request; and otherwise, the processing failure prompt information may be returned to the access party. By increasing the authorized access time limit, time verification is added when the permission verification is performed on the access user, thereby further improving the security of data processing.

In some embodiments of the present disclosure, the database processing method may further include: receiving an authorization deletion instruction sent by the data party, where the authorization deletion instruction carries a user identifier of the data party, a data identifier of the specified data and a user identifier of the authorized user, and the authorization deletion instruction is used for instructing to delete configuration information that the authorized user is authorized and allowed to access the specified data; and in response to the authorization deletion instruction, deleting, from the authorization information table, a correspondence among the user identifier of the data party, the data identifier of the specified data and the user identifier of the authorized user.

The authorization deletion instruction may be an instruction used for deleting authorized access user information configured for the encrypted data, the authorization deletion instruction includes a user identifier of an authorized user who needs to be deleted, and may further include a data identifier of data to be deleted and the user identifier of the corresponding data party. In the embodiments of the present disclosure, it is taken as an example that the data to be deleted is the specified data, and then the authorization deletion instruction may further include the data identifier of the specified data and the user identifier of the data party.

The data processing apparatus receives the authorization deletion instruction sent by the data party, and in response to the authorization deletion instruction, deletes, from the authorization information table, at least one of the user identifier of the data party, the data identifier of the specified data and the user identifier of the authorized user, so as to delete the correspondence among the user identifier of the data party, the data identifier of the specified data and the user identifier of the authorized user. In the present solution, it is supported to delete the configuration information that the authorized user is authorized and allowed to access the specified data, so that the permission configuration of the data is more flexible, and the actual service requirements are better satisfied.

To implement the above embodiments, the present disclosure further provides a database processing apparatus.

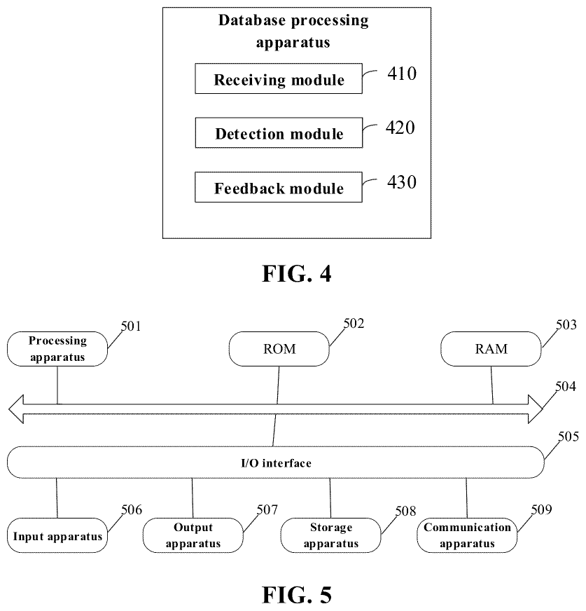

FIG. 4 is a schematic structural diagram of a database processing apparatus provided in an embodiment of the present disclosure, and the apparatus may be implemented by software and/or hardware, and may be generally integrated in an electronic device for database processing. As shown in FIG. 4, the apparatus includes a receiving module 410, a detection module 420 and a feedback module 430.

The receiving module 410 is configured to receive an access request for a database, wherein the access request carries a user identifier of an access party and a data processing instruction, the data processing instruction is used for instructing to process specified data in the database to obtain target data, and the database is deployed in a separate secure execution environment.

The detection module 420 is configured to: in response to determining that the specified data is encrypted data, query an authorization information table in the database based on the user identifier of the access party, and detect whether the access party is an authorized user of the specified data, wherein the encrypted data is data stored in the database in an encrypted form, and the authorization information table is used for recording authorized user information configured by a data party for the encrypted data.

The feedback module 430 is configured to: in response to determining that the access party is the authorized user of the specified data, execute the data processing instruction to process the specified data to obtain the target data, and return the target data in response to the access request.

Optionally, the apparatus further includes an authorization configuration module, configured to:
receive an authorization configuration instruction sent by the data party, wherein the authorization configuration instruction carries a user identifier of the data party, a data identifier of the specified data and a user identifier of the authorized user, and the authorization configuration instruction is used for instructing to configure that the authorized user is authorized and allowed to access to the specified data; and
in response to the authorization configuration instruction, record, in the authorization information table, a correspondence among the user identifier of the data party, the data identifier of the specified data and the user identifier of the authorized user.

Optionally, the authorization configuration instruction further includes an authorized access time limit; the authorization information table records a correspondence among the user identifier of the data party, the data identifier of the specified data, the user identifier of the authorized user and the authorized access time limit; and the authorized access time limit is used for limiting an access time of the authorized user for the specified data.

Optionally, the apparatus further includes an authorization deletion module, configured to:
receive an authorization deletion instruction sent by the data party, wherein the authorization deletion instruction carries a user identifier of the data party, a data identifier of the specified data and a user identifier of the authorized user, and the authorization deletion instruction is used for instructing to delete configuration information that the authorized user is authorized and allowed to access the specified data; and
in response to the authorization deletion instruction, delete, from the authorization information table, a correspondence among the user identifier of the data party, the data identifier of the specified data and the user identifier of the authorized user.

Optionally, user identifiers of a plurality of authorized users are configured for one piece of specified data of the data party in the authorization information table.

Optionally, the authorization information table is dynamically updated with the authorization configuration instruction sent by the data party.

Optionally, the specified data is at least one column of encrypted data in at least one data table corresponding to a specified column identifier, or,
the specified data is at least one row of encrypted data in at least one data table corresponding to a specified row identifier, or,
the specified data is at least one encrypted data element in at least one data table corresponding to the specified column identifier and the specified row identifier.

Optionally, the database is deployed in a trusted execution environment.

Optionally, the database is deployed in a trusted hardware based trusted execution environment.

The database processing apparatus provided in the embodiments of the present disclosure may execute the database processing method provided in any embodiment of the present disclosure, and has corresponding functional modules and beneficial effects for executing the method, the implementation principles of the database processing apparatus are similar, and thus no repeated description is given herein.

To implement the above embodiments, the present disclosure further provides a computer program product, including a computer program/instruction that, when executed by a processor, implements the database processing method in the above embodiments.

FIG. 5 is a schematic structural diagram of an electronic device provided in an embodiment of the present disclosure.

Specific reference is made to FIG. 5 below, it illustrates a structural schematic diagram of an electronic device 500 suitable for implementing an embodiment of the present disclosure. The electronic device 500 in the embodiment of the present disclosure may include, but is not limited to, mobile terminals such as mobile phones, notebook computers, digital broadcast receivers, PDAs (Personal Digital Assistants), PADs (Portable Android Devices), PMPs (Portable Multimedia Players), in-vehicle terminals (e.g., in-vehicle navigation terminals), and the like, and fixed terminals such as digital TVs, desktop computers, etc. The electronic device shown in FIG. 5 is merely an example and should not bring any limitation to the functions and use ranges of the embodiments of the present disclosure.

As shown in FIG. 5, the electronic device 500 may include a processing apparatus (e.g., a central processing unit, a graphics processing unit, or the like) 501, which may perform various suitable actions and processes in accordance with a program stored in a read-only memory (ROM) 502 or a program loaded from a storage apparatus 508 into a random access memory (RAM) 503. In the RAM 503, various programs and data needed by the operations of the electronic device 500 are also stored. The processing apparatus 501, the ROM 502 and the RAM 503 are connected to each other via a bus 504. An input/output (I/O) interface 505 is also connected to the bus 504.

In general, the following apparatuses may be connected to the I/O interface 505: an input apparatus 506, including, for example, a touch screen, a touch pad, a keyboard, a mouse, a camera, a microphone, an accelerometer, a gyroscope, and the like; an output apparatus 507, including, for example, a liquid crystal display (LCD), a speaker, a vibrator, and the like; a storage apparatus 508, including, for example, a magnetic tape, a hard disk, and the like; and a communication apparatus 509. The communication apparatus 509 may allow the electronic device 500 to communicate in a wireless or wired manner with other devices to exchange data. Although FIG. 5 illustrates the electronic device 500 having various apparatuses, it should be understood that not all illustrated apparatuses are required to be implemented or provided. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, and the computer program contains program codes for executing the method illustrated in the flowcharts. In such embodiments, the computer program may be downloaded and installed from a network via the communication apparatus 509, or installed from the storage apparatus 508, or installed from the ROM 502. When the computer program is executed by the processing apparatus 501, the above functions defined in the database processing method of the embodiments of the present disclosure are executed.

It should be noted that, the computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or a flash memory), an optical fiber, a compact disc-read-only memory (CD-ROM), an optical storage device, a magnetic storage device, or any suitable combination of the above. In the present disclosure, the computer-readable storage medium may be any tangible medium that contains or stores a program that may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transmit the program for use by or in combination with the instruction execution system, apparatus or device. Program codes contained on the computer-readable medium may be transmitted with any suitable medium, including, but not limited to: an electrical wire, an optical cable, RF (Radio Frequency), and the like, or any suitable combination thereof.

In some embodiments, a client and a server may perform communication by using any currently known or future-developed network protocol, such as an HTTP (HyperText Transfer Protocol), and may be interconnected with any form or medium of digital data communication (e.g., a communication network). Examples of the communication network include a local area network (“LAN”), a wide area network (“WAN”), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when executed by the electronic device, cause the electronic device to:
receive an access request for a database, wherein the access request carries a user identifier of an access party and a data processing instruction, the data processing instruction is used for instructing to process specified data in the database to obtain target data, and the database is deployed in an separate secure execution environment; in response to determining that the specified data is encrypted data, query an authorization information table in the database based on the user identifier of the access party, and detect whether the access party is an authorized user of the specified data, wherein the encrypted data is data stored in the database in an encrypted form, and the authorization information table is used for recording authorized user information configured by a data party for the encrypted data; and in response to determining that the access party is the authorized user of the specified data, execute the data processing instruction to process the specified data to obtain the target data, and return the target data in response to the access request. In the embodiments of the present disclosure, the database is completely packaged in the separate secure execution environment, so that the database is integrated with the executable environment, and related data is isolated in the executable environment, thereby not only ensuring the security of data, but also improving efficiency of data processing. In this way, the interaction between a client and the database is more convenient, there is no need to encrypt the data and then transmit the same on the client, and there is also no need for the database to perform frequent data interaction with another security platform. Moreover, in the present solution, encryption detection is performed on the specified data corresponding to the data processing instruction in the access request sent by the access party, in response to determining that the specified data is encrypted data, authorization detection is performed for the user identifier of the access party based on the authorization information table in the database, a corresponding processing operation is executed on the specified data according to an authorization detection result, and feedback is performed, thereby ensuring the security and reliability of data processing.

Computer program codes for executing the operations of the present disclosure may be written in one or more programming languages or combinations thereof. The programming languages include, but are not limited to, object node-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including a local area network (LAN) or a wide area network (WAN), or it may be connected to an external computer (e.g., through the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially in parallel, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case.

The functions described herein above may be executed, at least in part, by one or more hardware logical components. For example, without limitation, example types of the hardware logical components that may be used include: a field programmable gate array (FPGA), an application specific integrated circuit (ASIC), an application specific standard product (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium would include an electrical connection based on one or more wires, a portable computer disk, a hard disk, a random access memory (RAM), a read-only memory (ROM), an erasable programmable read-only memory (EPROM or a flash memory), an optical fiber, a compact disc-read-only memory (CD-ROM), an optical storage device, a magnetic storage device, or any suitable combination thereof.

What have been described above are only preferred embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to).

In addition, although various operations are described in a particular order, this should not be understood as requiring that these operations are executed in the particular sequence shown or in a sequential order. In certain environments, multitasking and parallel processing may be advantageous. Similarly, although several specific implementation details have been contained in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

Although the subject matter has been described in language specific to structural features and/or methodological actions, it should be understood that the subject matter defined in the appended claims is not necessarily limited to the specific features or actions described above. Rather, the specific features and actions described above are merely example forms of implementing the claims.

I/We claim:

1. A database processing method, comprising:
receiving an access request for a database, wherein the access request carries a user identifier of an access party and a data processing instruction, the data processing instruction is used for instructing to process specified data in the database to obtain target data, and the database is deployed in a separate secure execution environment;
in response to determining that the specified data is encrypted data, querying an authorization information table in the database based on the user identifier of the access party, and detecting whether the access party is an authorized user of the specified data, wherein the encrypted data is data stored in the database in an encrypted form, and the authorization information table is used for recording authorized user information configured by a data party for the encrypted data; and
in response to determining that the access party is the authorized user of the specified data, executing the data processing instruction to process the specified data to obtain the target data, and returning the target data in response to the access request.

2. The method according to claim 1, further comprising:
receiving an authorization configuration instruction sent by the data party, wherein the authorization configuration instruction carries a user identifier of the data party, a data identifier of the specified data and a user identifier of the authorized user, and the authorization configuration instruction is used for instructing to configure that the authorized user is authorized and allowed to access to the specified data; and
in response to the authorization configuration instruction, recording, in the authorization information table, a correspondence among the user identifier of the data party, the data identifier of the specified data and the user identifier of the authorized user.

3. The method according to claim 2, wherein the authorization configuration instruction further comprises an authorized access time limit; the authorization information table records a correspondence among the user identifier of the data party, the data identifier of the specified data, the user identifier of the authorized user and the authorized access time limit; and the authorized access time limit is used for limiting an access time of the authorized user for the specified data.

4. The method according to claim 1, further comprising:
receiving an authorization deletion instruction sent by the data party, wherein the authorization deletion instruction carries a user identifier of the data party, a data identifier of the specified data and a user identifier of the authorized user, and the authorization deletion instruction is used for instructing to delete configuration information that the authorized user is authorized and allowed to access the specified data; and
in response to the authorization deletion instruction, deleting, from the authorization information table, a correspondence among the user identifier of the data party, the data identifier of the specified data and the user identifier of the authorized user.

5. The method according to claim 1, wherein user identifiers of a plurality of authorized users are configured for one piece of specified data of the data party in the authorization information table.

6. The method according to claim 1, wherein the authorization information table is dynamically updated with the authorization configuration instruction sent by the data party.

7. The method according to claim 1, wherein the specified data is at least one column of encrypted data in at least one data table corresponding to a specified column identifier, or,
the specified data is at least one row of encrypted data in at least one data table corresponding to a specified row identifier, or,
the specified data is at least one encrypted data element in at least one data table corresponding to the specified column identifier and the specified row identifier.

8. The method according to claim 1, wherein the database is deployed in a trusted execution environment.

9. The method according to claim 1, wherein the database is deployed in a trusted hardware based trusted execution environment.

10. An electronic device, comprising:
a processor; and
a memory, configured to store an executable instruction for the processor, wherein,
the processor is configured to read the executable instruction from the memory, and when the processor executes the executable instruction, the processor is caused to:
receive an access request for a database, wherein the access request carries a user identifier of an access party and a data processing instruction, the data processing instruction is used for instructing to process specified data in the database to obtain target data, and the database is deployed in a separate secure execution environment;
in response to determining that the specified data is encrypted data, query an authorization information table in the database based on the user identifier of the access party, and detect whether the access party is an authorized user of the specified data, wherein the encrypted data is data stored in the database in an encrypted form, and the authorization information table is used for recording authorized user information configured by a data party for the encrypted data; and
in response to determining that the access party is the authorized user of the specified data, execute the data processing instruction to process the specified data to obtain the target data, and return the target data in response to the access request.

11. The electronic device according to claim 10, wherein the processor is further caused to:
receive an authorization configuration instruction sent by the data party, wherein the authorization configuration instruction carries a user identifier of the data party, a data identifier of the specified data and a user identifier of the authorized user, and the authorization configuration instruction is used for instructing to configure that the authorized user is authorized and allowed to access to the specified data; and
in response to the authorization configuration instruction, record, in the authorization information table, a correspondence among the user identifier of the data party, the data identifier of the specified data and the user identifier of the authorized user.

12. The electronic device according to claim 11, wherein the authorization configuration instruction further comprises an authorized access time limit; the authorization information table records a correspondence among the user identifier of the data party, the data identifier of the specified data, the user identifier of the authorized user and the authorized access time limit; and the authorized access time limit is used for limiting an access time of the authorized user for the specified data.

13. The electronic device according to claim 10, wherein the processor is further caused to:
receive an authorization deletion instruction sent by the data party, wherein the authorization deletion instruction carries a user identifier of the data party, a data identifier of the specified data and a user identifier of the authorized user, and the authorization deletion instruction is used for instructing to delete configuration information that the authorized user is authorized and allowed to access the specified data; and
in response to the authorization deletion instruction, delete, from the authorization information table, a correspondence among the user identifier of the data party, the data identifier of the specified data and the user identifier of the authorized user.

14. The electronic device according to claim 10, wherein user identifiers of a plurality of authorized users are configured for one piece of specified data of the data party in the authorization information table.

15. The electronic device according to claim 10, wherein the authorization information table is dynamically updated with the authorization configuration instruction sent by the data party.

16. The electronic device according to claim 10, wherein the specified data is at least one column of encrypted data in at least one data table corresponding to a specified column identifier, or,
the specified data is at least one row of encrypted data in at least one data table corresponding to a specified row identifier, or,
the specified data is at least one encrypted data element in at least one data table corresponding to the specified column identifier and the specified row identifier.

17. The electronic device according to claim 10, wherein the database is deployed in a trusted execution environment.

18. The electronic device according to claim 10, wherein the database is deployed in a trusted hardware based trusted execution environment.

19. A non-transitory computer-readable storage medium, storing a computer program, wherein the computer program is configured to:
receive an access request for a database, wherein the access request carries a user identifier of an access party and a data processing instruction, the data processing instruction is used for instructing to process specified data in the database to obtain target data, and the database is deployed in a separate secure execution environment;
in response to determining that the specified data is encrypted data, query an authorization information table in the database based on the user identifier of the access party, and detect whether the access party is an authorized user of the specified data, wherein the encrypted data is data stored in the database in an encrypted form, and the authorization information table is used for recording authorized user information configured by a data party for the encrypted data; and
in response to determining that the access party is the authorized user of the specified data, execute the data processing instruction to process the specified data to obtain the target data, and return the target data in response to the access request.

20. The non-transitory computer-readable storage medium according to claim 19, wherein the computer program is configured to:
receive an authorization configuration instruction sent by the data party, wherein the authorization configuration instruction carries a user identifier of the data party, a data identifier of the specified data and a user identifier of the authorized user, and the authorization configuration instruction is used for instructing to configure that the authorized user is authorized and allowed to access to the specified data; and
in response to the authorization configuration instruction, record, in the authorization information table, a correspondence among the user identifier of the data party, the data identifier of the specified data and the user identifier of the authorized user.
